(19) United States
(12) Patent Application Publication
(10) Pub. No.: US 2026/0236460 A1
(43) Pub. Date: Aug. 13, 2026

(54) DECLARATIVE AI INTEGRATION FRAMEWORK

(71) Applicant: SAP SE, Walldorf (DE)

(72) Inventor: Manikandan RAJASEKAR, Bangalore (IN)

(21) Appl. No.: 19/051,540

(22) Filed: Feb. 12, 2025

(51) Int. Cl. G06F 16/242

(52) U.S. Cl. CPC G06F 16/2438

(57) ABSTRACT

Systems and methods include reception of a request from an application for text generation including a scenario identifier and a payload, determination of a stored scenario definition associated with the scenario identifier, determination of a prompt template definition from the scenario definition, determination of a model deployment from the scenario definition, generation of a prompt based on the prompt template definition and the payload, transmission of the prompt to the model deployment, reception of a response to the prompt from the model deployment, and return of the response to the application.

### BACKGROUND

Modern database systems store vast amounts of data for their respective enterprises. Software applications are employed to access this stored data in order to perform various functions. These functions are increasingly provided via integration with neural networks, or machine learning (ML) models. The machine learning models may include, for example, custom models trained on private data or publicly-available Large Language Models (LLMs). By leveraging the predictive algorithms of these models, software applications may suggest inputs, predict numerical and/or textual values, generate summaries, descriptions, reports and emails, and recommend next steps or actions.

Incorporating ML model functionalities into software applications requires significant infrastructure and development resources. For example, developers must adjust existing application logic to seamlessly integrate desired ML model functionalities. The integration must be continually refined in order to adapt to changes in model endpoints, interfaces, and outputs, to adopt new models, or to adapt to changes in application logic. These refinements may adversely impact application stability, necessitating updates to test cases and other quality assurance measures.

Systems are desired to integrate ML model functionality with software applications while minimizing development requirements, maintenance requirements and disruptions due to application instability.

### BRIEF DESCRIPTION OF THE DRAWINGS

FIG. 1 is a block diagram of an architecture to declaratively establish generative model deployments according to some embodiments.

FIG. 2 is a flow diagram of a process to declaratively establish generative model deployments according to some embodiments.

FIG. 3 is a block diagram of an architecture to provide declaratively-established generative model deployments to application tenants according to some embodiments.

FIG. 4 is a modelling diagram of entities according to some embodiments.

FIG. 5 is a schema of an AI scenario descriptor according to some embodiments.

FIG. 6 is a schema of a prompt template definition according to some embodiments.

FIG. 7 is a schema of an embeddings definition according to some embodiments.

FIG. 8 is a flow diagram of a process to provide declaratively-established generative model deployments to application tenants according to some embodiments.

FIG. 9 is a block diagram of an architecture to provide declaratively-established generative model deployments to multiple applications and multiple application tenants according to some embodiments.

FIG. 10 is a block diagram of a cloud-based system according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Embodiments may provide a structured, declarative approach for integrating Generative AI (Gen AI) capabilities into applications, regardless of their code stack or underlying architecture (i.e., whether they are extensions, plugins, single-tenant, or multi-tenant). Generally, embodiments allow developers to define desired Gen AI integration scenarios in a flat file which encapsulates intended Gen AI interactions and is deployed alongside an application. At runtime, an integration service ensures that the desired Gen AI scenarios are fulfilled as defined in the flat files. Embodiments may thereby significantly reduce the complexities traditionally associated with setting up and managing LLM deployments, while ensuring immediate availability and operational efficiency. The integration service may comprise a central platform shared across various applications and tenants.

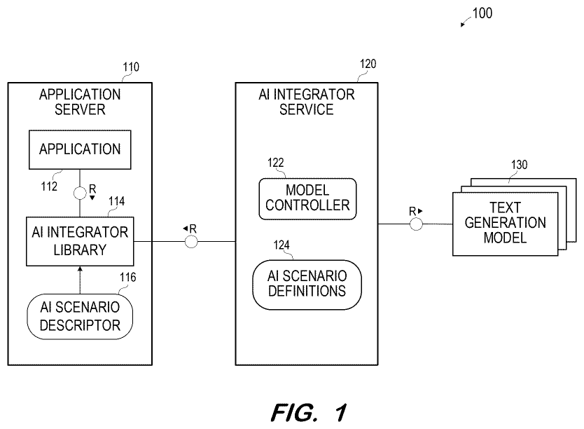

FIG. 1 is a block diagram of a design-time architecture of system 100 to declaratively establish generative model deployments according to some embodiments. The illustrated elements of system 100 may be implemented using any suitable combination of local, on-premise, cloud-based, distributed (e.g., including distributed storage and/or compute nodes) computing hardware and/or software that is or becomes known. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service). Such implementations apportion computing resources elastically according to demand, need, price, and/or any other metric.

Each component described herein may be executed by one or more physical and/or virtualized servers. In particular, each execution environment depicted herein may comprise one or more physical servers, virtual machines, clusters of a container orchestration system, or other implementation providing an operating system, services, I/O, storage, libraries, frameworks, etc. to applications executing therein. For example, application server 110 is an execution environment which may comprise an on-premise or cloud-based server providing an execution platform and services to applications such as application 112.

Application 112 may comprise an application providing functions to users based on coded logic and stored data (not shown) as is known in the art. The application logic may create, read, update and delete data based on a data schema consisting of semantic objects as is known in the art. The data may comprise relational database tables and views whose columns conform to a data schema defined by metadata. Application 112 may comprise a single-tenant or multi-tenant application.

AI integrator library 114 exposes programming interfaces including Application Programming Interfaces that facilitate the consumption of Gen AI capabilities. These interfaces may enable the application 112 to integrate Gen AI capabilities with minimal code while ensuring adherence to standardized Gen AI interaction patterns. For example, a developer of application 112 may determine that certain functions of application 112 may benefit from ML model inferences. The developer may therefore write code of application 112 to call interfaces of AI integrator library 114 in order to request such inferences when needed. To facilitate creation of the calling code, AI integrator library 114 and its interfaces may conform to the code stack of application 112.

The developer also creates AI scenario descriptor 116 representing a desired Gen AI integration state. Descriptor 116 is a markup language (e.g., Yet Another Markup Language) file specifying a Gen AI model (e.g., an LLM) from which an inference is to be requested, one or more prompt templates, and zero or more context sources to be included in a prompt to the model. Application server 110 may store AI scenario descriptors for use by application 112. Calls received from application 112 by library 114 may therefore include an identifier of an AI scenario descriptor, an identifier of a prompt template listed in identified AI scenario descriptor, and a payload.

AI integrator library 114 establishes a connection between application 112 and AI integrator service 120. The connection triggers service 120 to scan, using an exposed endpoint of AI integrator library 114, for AI scenario descriptor files such as AI scenario descriptor 116. AI integrator service 120 stores any retrieved AI scenario descriptors as AI scenario definitions 124.

AI scenario definitions 124 may specify Gen AI model types. Model controller 122 of AI integrator service 120 identifies and locates text generation models 130 specified in stored AI scenario definitions 124. Each of text generation models 130 may comprise a neural network trained to generate text in response to input text (i.e., a prompt).

A text generation model 130 may be implemented by, for example, executable program code, a set of hyperparameters defining a model structure and a set of corresponding weights, or any other representation of an input-to-output mapping which was learned as a result of the training. According to some embodiments, each text generation model 130 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Text generation models 130 may be trained based on public and/or private data. Non-exhaustive examples of text generation models 130 include GPT-4, LaMDA, and Claude. Models 130 may be exposed by one or more hyperscalers or otherwise deployed within a landscape which is trusted by a provider of application server 110.

Model controller 122 ensures that the specified models are properly deployed and in a servable state with acceptable latency. Model controller 122 monitors the health status of each model deployment and updates the statuses in corresponding AI scenario definitions 124. AI integrator service 120 may return model deployment status updates to an exposed endpoint of AI integrator library 114. AI integrator library 114 may inform connected applications of model deployment status to ensure that users do not encounter failures during prompt executions.

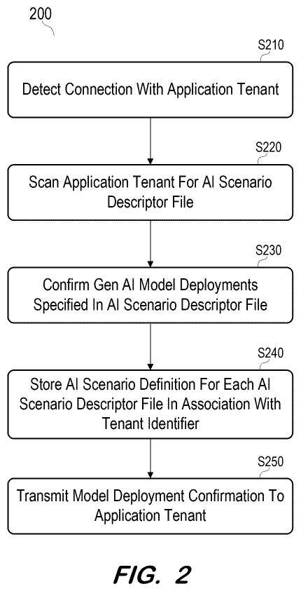

FIG. 2 comprises a flow diagram of process 200 to declaratively establish generative model deployments according to some embodiments. Process 200 will be described with respect to the elements of system 100, but embodiments are not limited thereto.

Process 200 and all other processes mentioned herein may be embodied in processor-executable program code read from one or more of non-transitory computer-readable media, such as a hard disk drive, a volatile or non-volatile random-access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to process 200, a connection is created between an application and an AI integrator service such as service 120. For example, if the application runs in a Java stack, AI integrator library 114 may leverage native Java interfaces to fetch a connection to AI integrator service 120 based on a name provided by the application. The connected application is referred to herein as an application tenant, such that each tenant of a given application may be associated with a respective set of one or more AI scenario descriptors.

AI integrator service 120 detects the connection at S210. In response, service 120 scans the application tenant for AI scenario descriptors at S220. As described above, using an exposed endpoint of AI integrator library 114, AI integrator service 120 may retrieve any AI scenario descriptors associated with the connected application tenant and 116 and known to AI integrator library 114.

The model deployments specified in each retrieved AI scenario descriptor are confirmed at S230. For example, model controller 122 of AI integrator service 120 may contact the specified model deployments to ensure that the models are properly deployed and in a servable state with acceptable latency. An AI scenario definition is stored for each AI scenario descriptor at S240. A stored AI scenario definition may include the information of its corresponding AI scenario descriptor and statuses and identifiers of its specified model deployments. Each AI scenario definition may be stored in association with an identifier of the application tenant.

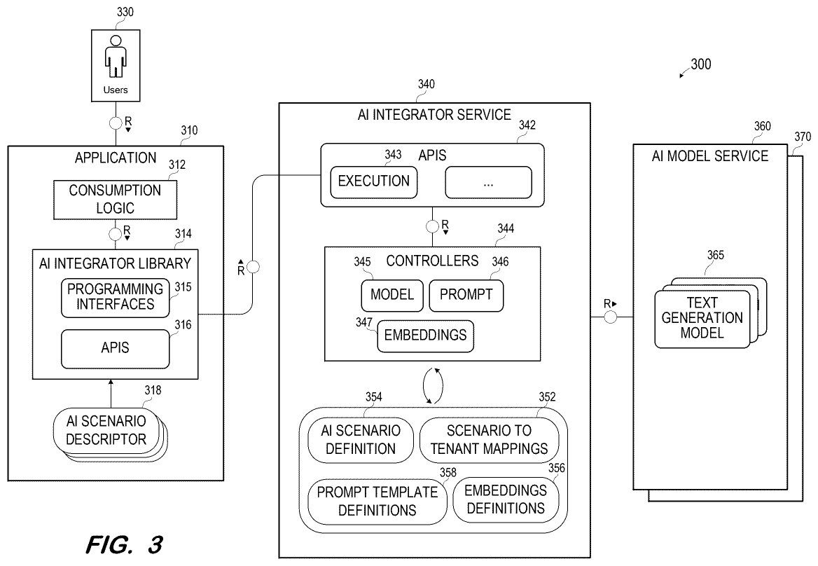

A model deployment confirmation is transmitted to the application tenant at S250. The confirmation indicates to the application tenant that the models are available to be consumed. FIG. 3 is a block diagram of architecture 300 to consume declaratively-established generative model deployments according to some embodiments.

Architecture 300 includes application 310, depicted as including consumption logic 312, AI integrator library 314 and multiple AI scenario descriptors 318. Consumption logic 312 is executable to request Gen AI inferences using programming interfaces 315 of library 314, and to receive Gen AI responses therefrom. In this regard, AI integrator library exposes APIs 316 usable to post Gen AI responses, to post model status, and to discovery AI scenario descriptors 318. Application 310 also includes other unshown logic for providing respective functions to users 320.

Users 330 may comprise users of one tenant or of multiple tenants (if application 310 is a multi-tenant application). Users 330 operate user devices (not shown) to interact with application 310 to create, manage, edit, and/or view data based on the functions provided by application 310. During various stages of such interaction, application 310 may execute consumption logic 312 to request an inference using library 314. The request may specify one of AI scenario descriptors 318, a model of the specified descriptor 318, a prompt template of the specified descriptor and a payload. The particular descriptor 318, prompt template and payload depending on the particular functions and data for which the inference is desired.

AI integrator service 340 includes APIs 342 for use by AI integrator library 314. In response to a request, integrator library 314 may call execution API 343 of APIs 342. The call may include the payload and the identifiers of the scenario and of the prompt template specified in the request. The call may also identify the application tenant from whom the call was received. The scenario and tenant identifiers may be compared with scenario-to-tenant mappings 352 to identify a stored AI scenario definition 354 which corresponds to the request.

Each scenario definition 354 is associated with one or more prompt template definitions 358 and zero or more embeddings definitions 359. The prompt template definitions 358 and embeddings definitions 359 associated with a scenario definition 354 may be included within the corresponding declarative AI scenario descriptor 318. Accordingly, an AI scenario descriptor 318 is converted to a scenario definition 354, one or more prompt template definitions 358, and zero or more embeddings definitions 359 when discovered by AI integrator service 340.

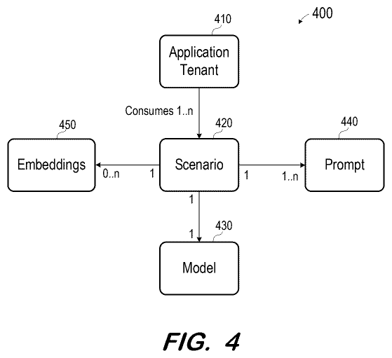

FIG. 4 illustrates modelling diagram 400 of entities according to some embodiments. Each application tenant 410 may consume one or more Gen AI scenarios 420, each of which is described by an AI scenario descriptor. Each Gen AI scenario 420 may be associated with a Gen AI model 430 specified in its AI scenario descriptor and with one or more prompts 440 identified in its AI scenario descriptor and described in separate respective prompt template definitions. Each Gen AI scenario 420 may also be associated with zero or more embeddings 450 identified in its AI scenario descriptor and described in separate respective embeddings definitions.

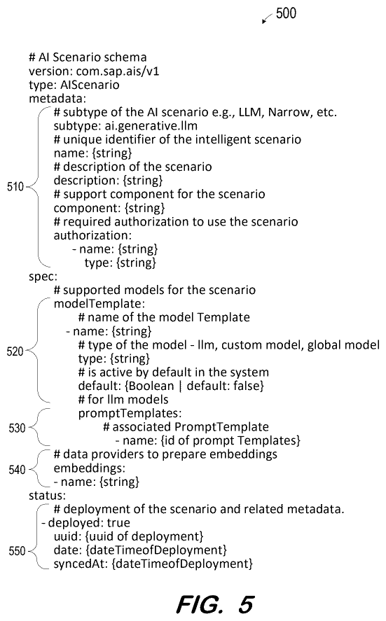

FIG. 5 is an example of schema 500 of an AI scenario descriptor according to some embodiments. Fields 510 of schema 500 describe scenario metadata such as scenario name, scenario description, required authorizations, etc. Fields 520 define a model associated with the scenario and field 530 specifies identifiers of one or more prompt templates associated with the scenario. Similarly, field 540 specifies identifiers of one or more embeddings associated with the scenario. Schema 500 also includes fields 550 for tracking deployment status of the scenario. Fields 550 allow an AI integrator library at an application tenant to update the AI scenario descriptors of the application with their deployment statuses based on status information provided by an AI integrator service.

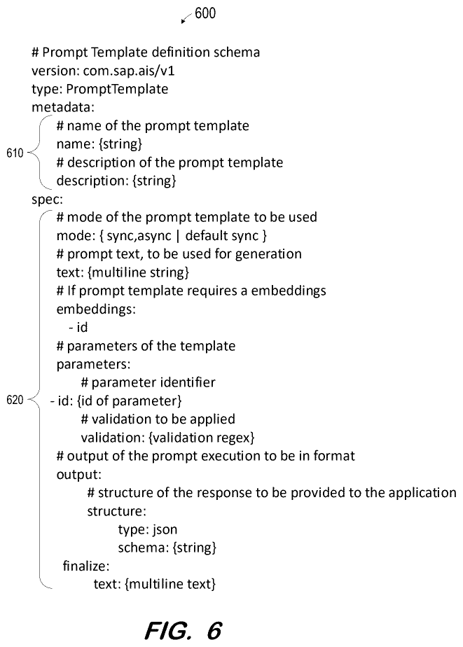

FIG. 6 shows schema 600 of a prompt template definition according to some embodiments. Each prompt template identifier of an AI scenario descriptor refers to an instance of schema 600. Fields 610 provide a name and a description of a prompt template, while fields 620 define the contents of the prompt template. Fields 620 specify a mode (synchronous, asynchronous), text, input parameters, input parameter validations, and identifiers of any embeddings to be included in the prompt template. Fields 620 may also specify an output structure of the response to be generated by the prompt template.

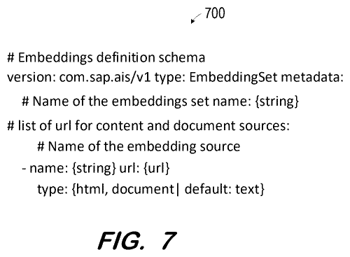

FIG. 7 shows schema 700 of an embeddings definition according to some embodiments. Each embeddings identifier of a prompt template definition refers to an instance of schema 700. Schema 700 allows specification of the name, type and location of one or more text sources to be included (in embedding form) in a prompt template as prompt context.

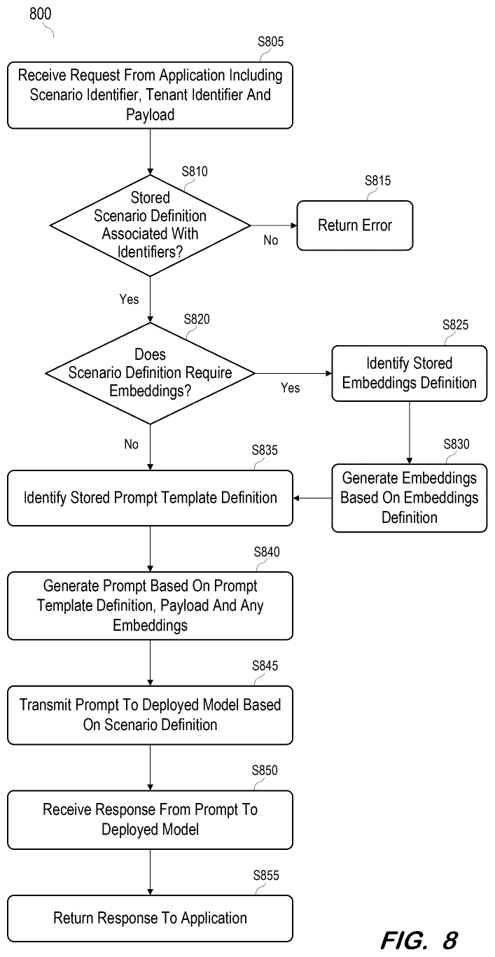

FIG. 8 is a flow diagram of a process to provide declaratively-established generative model deployments to application tenants according to some embodiments. Process 800 may be executed by an AI integrator service such as service 340, but embodiments are not limited thereto. Process 800 assumes that a connection has been established between an application tenant and an AI integrator service.

Initially, at S805, a request for an inference is received from an application. The request includes an identifier of an AI scenario descriptor, a tenant identifier and a payload based on which a Gen AI response is desired. If the identified AI scenario descriptor identifies more than one prompt template, the request may also include a prompt template identifier.

At S810, it is determined whether any stored scenario definition is associated with the scenario descriptor identifier and the tenant identifier. If not, the AI scenario descriptor has not been deployed for the tenant and an error is returned to the application at S815. The determination at S810 may also be negative if a stored scenario definition associated with the scenario descriptor identifier and the tenant identifier exists but indicates a problem (e.g., status: unavailable).

Upon identifying a stored scenario definition at S810, it is determined whether the scenario definition specifies any embeddings. If so, identifiers of the specified embeddings are used at S825 to identify corresponding stored embeddings definitions. Next, at S830, text sources identified in the embeddings definitions are retrieved and embeddings are generated therefrom. For example, each text source may be independently submitted to a trained embeddings model to acquire a multi-dimensional numerical vector which represents semantics of the text source. The AI integrator service, rather than the application, manages connections to such embeddings models and the interactions therewith. Flow then proceeds to S835.

Flow also proceeds to S835 from S820 to identify a stored prompt template definition. The stored prompt template definition may be identified based on a prompt template identifier of the stored scenario definition. If the stored scenario definition includes more than one prompt template identifier, the stored prompt template definition may be identified at S835 based on a prompt template identifier received with the request at S805.

A prompt is generated at S840 based on the identified prompt template definition, the payload, and embeddings generated at S830, if any. The generated prompt includes text as described by the prompt template definition, the embeddings and the payload. The generated prompt may comprise a system prompt including the prompt template definition and the embeddings, and a user prompt including the payload.

The prompt is transmitted to the model specified in the scenario definition at S845. As described above, the AI integrator service monitors and maintains a connection to the model specified in each stored scenario definition. The AI integrator service uses such a connection to transmit the prompt to the model at S845. A response is received from the model at S850 and the response is returned to the application at S855. The response may be returned to an integrator library of the application and passed therefrom to the application.

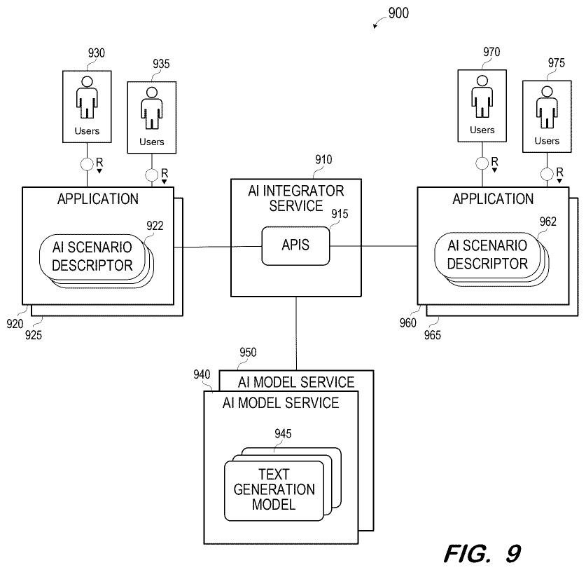

FIG. 9 is a diagram of architecture 900 in which AI integrator service 910 is used by multiple applications and application tenants. Deployment of service 910 in a centralized manner optimizes resource utilization while reducing operational overhead. Moreover, the automated AI scenario discovery described herein allows for flexible management across large-scale landscapes using a single shared service.

AI integrator service 910 includes execution and other APIs 915 as described above. Although not shown in FIG. 9, service 910 also includes controllers and stored mappings and definitions as described.

Applications 920 and 925 are assumed to be identical applications deployed on different tenant systems. Each of applications 920 and 925 includes application logic, Gen AI scenario consumption logic, and an AI integrator library for communication with AI integrator service 910. Each of applications 920 and 925 includes a plurality of declarative AI scenario descriptors 922, which may differ between applications 920 and 925. Each tenant system may be operated by a different enterprise, but embodiments are not limited thereto.

Upon establishing a connection with each of applications 920 and 925 and retrieving AI scenario descriptors 922, AI integrator service 910 creates and stores corresponding AI scenario definitions, prompt template definitions and embeddings definitions as described above. Application 920 may receive requests from users 930 of its tenant. Application 920 may determine that one of the received requests requires Gen AI functionality and call an AI scenario described by one of descriptors 922. AI integrator service may then execute process 800 based on the call to prompt one of models 945 of model services 940 or 950 and return the resulting response.

Applications 960 and 965 may also be identical applications but different from applications 920 and 925. Applications 960 and 965 may be deployed on different tenant systems. AI integrator service 910 also creates and stores AI scenario definitions, prompt template definitions and embeddings definitions corresponding to AI scenario descriptors 962. In response to requests from respective users 970 or 975, applications 960 or 965 may call an AI scenario described by one of descriptors 962, causing AI integrator service to execute process 800 based on the call to prompt one of models 945 of model services 940 or 950 and to return the resulting response.

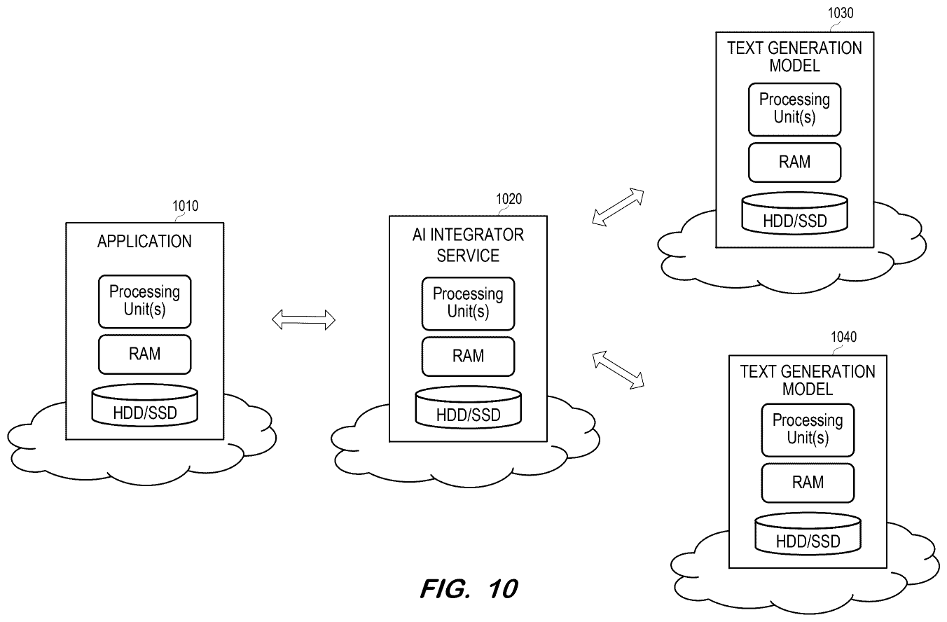

FIG. 10 is a diagram of a cloud-based implementation according to some embodiments. Generally, application 1010 may request Gen AI inferences from AI integrator service 1020 based on stored AI scenario descriptors. AI integrator service 1020 may, in turn, generate prompts based on AI scenario definitions, prompt template definitions and embeddings definitions which were generated and stored based on the AI scenario descriptors. AI integrator service 1020 may transmit the prompts to text generation model 1030 and/or text generation model 1040 and return responses to application 1010. Each of systems 1010 through 1140 may comprise cloud-based resources residing in one or more public clouds providing self-service and immediate provisioning, autoscaling, security, compliance and identity management features. Each of systems 1010 through 1040 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

1. A system comprising:
a memory storing executable program code;
one or more processing units to execute the program code to cause the system to:
detect a connection with an application;
in response to the detected connection, scan the application for an associated Artificial Intelligence (AI) scenario descriptor file specifying a Generative AI (GenAI) model deployment and a prompt template;
identify a text generation model that fulfills the specified GenAI model deployment;
confirm the text generation model is available to be consumed;
in response to the confirmation, store an AI scenario definition identifying the text generation model and the prompt template, and transmit a model deployment confirmation to the application;
receive a request from the application for text generation including a scenario identifier and a payload;
identify the stored scenario definition based on the scenario identifier;
determine the prompt template identified by the scenario definition;
determine the text generation model identified by the scenario definition;
generate a prompt based on the prompt template and the payload;
transmit the prompt to the text generation model;
receive a response to the prompt from the text generation model; and
return the response to an integrator library of the application.

2. The system of claim 1, wherein the request includes a tenant identifier, and wherein determination of the stored scenario definition comprises determination of the stored scenario definition associated with the scenario identifier and the tenant identifier.

3. The system of claim 2, the one or more processing units to execute the program code to cause the system to:
determine an embedding definition from the scenario definition;
generate an embedding based on the embedding definition; and
generate the prompt based on the prompt template, the embedding and the payload.

4. The system of claim 1, the one or more processing units to execute the program code to cause the system to:
determine an embedding definition from the scenario definition;
generate an embedding based on the embedding definition; and
generate the prompt based on the prompt template, the embedding and the payload.

5. The system of claim 1, the one or more processing units to execute the program code to cause the system to:
receive a second request from a second application for text generation including a second scenario identifier and a second payload;
identify a second stored scenario definition based on the second scenario identifier;
determine a second prompt template identified by the second scenario definition;
determine a second text generation model identified by the second scenario definition;
generate a second prompt based on the second prompt template and the second payload;
transmit the second prompt to the second text generation model;
receive a second response to the second prompt from the second text generation model; and
return the second response to an integrator library of the second application.

6. The system of claim 5, wherein the request includes a tenant identifier, wherein the second request includes a second tenant identifier, wherein determination of the stored scenario definition comprises determination of the stored scenario definition associated with the scenario identifier and the tenant identifier, and wherein determination of the second stored scenario definition comprises determination of the second stored scenario definition associated with the second scenario identifier and the second tenant identifier.

7. The system of claim 1, the one or more processing units to execute the program code to cause the system to:
receive a second request from the application for text generation including a second scenario identifier and a second payload;
identify a second stored scenario definition based on the second scenario identifier;
determine a second prompt template identified by the second scenario definition;
determine a second text generation model identified by from the second scenario definition;
generate a second prompt based on the second prompt template and the second payload;
transmit the second prompt to the second text generation model;
receive a second response to the second prompt from the second text generation model; and
return the second response to the integrator library of the application.

8. The system of claim 7, wherein the request includes a tenant identifier, wherein the second request includes a second tenant identifier, wherein determination of the stored scenario definition comprises determination of the stored scenario definition associated with the scenario identifier and the tenant identifier, and wherein determination of the second stored scenario definition comprises determination of the second stored scenario definition associated with the second scenario identifier and the second tenant identifier.

9. A method comprising:
detecting a connection with an application;
in response to the detected connection, scanning the application for an associated Artificial Intelligence (AI) scenario descriptor file specifying a Generative AI (GenAI) model deployment and a prompt template;
identifying a text generation model that fulfills the specified GenAI model deployment;
confirming the text generation model is available to be consumed;
in response to the confirmation, storing an AI scenario definition identifying the text generation model and the prompt template, and transmitting a model deployment confirmation to the application;
receiving a request from the application for text generation, the request including a scenario identifier and a payload;
identifying the stored scenario definition based on the scenario identifier;
determining the prompt template identified by the scenario definition;
determining the text generation model identified by the scenario definition;
generating a prompt based on the prompt template and the payload;
transmitting the prompt to the text generation model;
receiving a response to the prompt from the text generation model; and
returning the response to an integrator library of the application.

10. The method of claim 9, wherein the request includes a tenant identifier, and wherein determination of the stored scenario definition comprises determination of the stored scenario definition associated with the scenario identifier and the tenant identifier.

11. The method of claim 10, further comprising:
determining an embedding definition from the scenario definition;
generating an embedding based on the embedding definition; and
generating the prompt based on the prompt template, the embedding and the payload.

12. The method of claim 9, further comprising:
determining an embedding definition from the scenario definition;
generating an embedding based on the embedding definition; and
generating a the prompt based on the prompt template, the embedding and the payload.

13. The method of claim 9, further comprising:
receiving a second request from a second application for text generation, the second request including a second scenario identifier and a second payload;
identifying a second stored scenario definition based on the second scenario identifier;
determining a second prompt template identified by the second scenario definition;
determining a second text generation model identified by the second scenario definition;
generating a second prompt based on the second prompt template and the second payload;
transmitting the second prompt to the second text generation model;
receiving a second response to the second prompt from the second text generation model; and
returning the second response to an integrator library of the second application.

14. The method of claim 13, wherein the request includes a tenant identifier, wherein the second request includes a second tenant identifier, wherein determination of the stored scenario definition comprises determination of the stored scenario definition associated with the scenario identifier and the tenant identifier, and wherein determination of the second stored scenario definition comprises determination of the second stored scenario definition associated with the second scenario identifier and the second tenant identifier.

15. The method of claim 9, further comprising:
receiving a second request from the application for text generation, the second request including a second scenario identifier and a second payload;
identifying a second stored scenario definition based on the second scenario identifier;
determining a second prompt template identified by the second scenario definition;
determining a second text generation model identified by the second scenario definition;
generating a second prompt based on the second prompt template and the second payload;
transmitting the second prompt to the second text generation model;
receiving a second response to the second prompt from the second text generation model; and
returning the second response to the integrator library of the application.

16. The method of claim 15, wherein the request includes a tenant identifier, wherein the second request includes a second tenant identifier, wherein determination of the stored scenario definition comprises determination of the stored scenario definition associated with the scenario identifier and the tenant identifier, and wherein determination of the second stored scenario definition comprises determination of the second stored scenario definition associated with the second scenario identifier and the second tenant identifier.

17. One or more non-transitory media storing program code executable by a computing system to cause the computing system to:
detect a connection with an application;
in response to the detected connection, scan the application for an associated Artificial Intelligence (AI) scenario descriptor file specifying a Generative AI (GenAI) model deployment and a prompt template;
identify a text generation model that fulfills the specified GenAI model deployment;
confirm the text generation model is available to be consumed;
in response to the confirmation, store an AI scenario definition identifying the text generation model and the prompt template, and transmit a model deployment confirmation to the application;
receive a request from the application for text generation including a scenario identifier and a payload;
identify a stored scenario definition based on the scenario identifier;
determine the prompt template identified by the scenario definition;
determine the text generation model identified by the scenario definition;
generate a prompt based on the prompt template and the payload;
transmit the prompt to the text generation model;
receive a response to the prompt from the text generation model; and
return the response to an integrator library of the application.

18. The one or more non-transitory media of claim 17, the program code executable by a computing system to cause the computing system to:
determine an embedding definition from the scenario definition;
generate an embedding based on the embedding definition; and
generate the prompt based on the prompt template, the embedding and the payload.

19. The one or more non-transitory media of claim 17, the program code executable by a computing system to cause the computing system to:
receive a second request from a second application for text generation including a second scenario identifier and a second payload;
identify a second stored scenario definition based on the second scenario identifier;
determine a second prompt template identified by the second scenario definition;
determine a second text generation model identified by the second scenario definition;
generate a second prompt based on the second prompt template and the second payload;
transmit the second prompt to the second text generation model;
receive a second response to the second prompt from the second text generation model; and
return the second response to an integrator library of the second application.

20. The one or more non-transitory media of claim 17, the program code executable by a computing system to cause the computing system to:
receive a second request from the application for text generation including a second scenario identifier and a second payload;
identify a second stored scenario definition based on the second scenario identifier;
determine a second prompt template identified by the second scenario definition;
determine a second text generation model identified by second scenario definition;
generate a second prompt based on the second prompt template and the second payload;
transmit the second prompt to the second text generation model;
receive a second response to the second prompt from the second text generation model; and
return the second response to the integrator library of the application.
